(19) United States
(12) Patent Application Publication
(10) Pub. No.: US 2026/0323775 A1
(43) Pub. Date: Oct. 15, 2026

(54) METHODS AND SYSTEMS FOR EMERGENCY APN CONNECTION

(71) Applicant: T-Mobile Innovations LLC, Overland Park, KS (US)

(72) Inventor: Manikanta Kumar Teja PENUMATSHA, Redmond, WA (US)

(21) Appl. No.: 19/175,222

(22) Filed: Apr. 10, 2025

(51) Int. Cl. H04W 76/50; H04L 65/1016; H04L 65/1104; H04W 76/20

(52) U.S. Cl. CPC H04W 76/50; H04L 65/1016; H04L 65/1104; H04W 76/20

(57) ABSTRACT

Methods and systems are provided for receiving, at a UE, a call invite from an emergency device, determining that the emergency device corresponds to an emergency callback number, requesting, at the UE, from a wireless network, an emergency access point name (APN) for the call, receiving, at the UE, an emergency APN for the call, and connecting to the emergency device using the emergency APN.

### TECHNICAL BACKGROUND

Cellular phones, such as smartphones, are often used for contacting emergency services. In some instances, the emergency service is contactable by a public safety answering point (PSAP). In some instances, after the initial emergency call session is terminated, a call may be made from an emergency number to the cellular phone. This call may be from the PSAP or may be from a particular emergency service and may be made to obtain further information or to provide updates to the caller. However, if a mobile communication network is unaware that the second call is related to an emergency service, the network may not prioritize the call to ensure connectivity between the cellular phone and the phone associated with the emergency number.

### OVERVIEW

Exemplary embodiments described herein include methods and systems for emergency access point name (APN) connection. An exemplary method includes receiving, at a UE, a call invite from an emergency device. The emergency device may be associated with the PSAP, emergency service and/or first responder and corresponds to an emergency callback number stored by the UE. The method then includes requesting, at the UE, an emergency APN for the call from the emergency device. The UE requests the emergency APN from a wireless network. The method continues with receiving an emergency APN for the call, with the emergency APN being received at the UE. The method then includes connecting to the emergency device using the emergency APN.

Another example method includes transmitting, to a UE, a call invite from an emergency device. The method then includes receiving, from the UE, a request for an emergency APN. The request for the emergency APN is particularly a request for an IMS APN for the call from the emergency device. The method continues with assigning an emergency APN for the call to the UE. The method then includes connecting the UE to the emergency device using the emergency APN.

An example system for emergency APN connection includes a memory storing data and instructions and a processor executing the stored instructions. The processor executes the stored instructions to perform operations including transmitting, to a UE, a call invite from an emergency device. The operations further include receiving, from the UE, a request for an emergency APN for the call from the emergency device. The operations then include assigning and transmitting an emergency APN for the call to the UE. The operations continue with connecting the UE to the emergency device using the emergency APN.

### BRIEF DESCRIPTION OF THE DRAWINGS

FIG. 1 illustrates an exemplary system for UE communication in accordance with disclosed embodiments.

FIG. 2 illustrates an example method of UE communication with an emergency device in accordance with disclosed embodiments.

FIG. 3 illustrates an example method for emergency APN connection in accordance with disclosed embodiments.

FIG. 4 illustrates another example method for emergency APN connection in accordance with disclosed embodiments.

FIG. 5 illustrates a computing device for emergency APN connection in accordance with disclosed embodiments.

### DETAILED DESCRIPTION

When an emergency call, such as a call to 911, is made, a public safety access point (PSAP) receives the call. The PSAP is connected to a variety of emergency services, such as police, fire, and emergency medical service (EMS). As such, the PSAP is able to coordinate aid to the caller of a UE based on information collected during the emergency call.

In some instances, after the initial call is completed, the PSAP or a particular emergency service may need to initiate a callback to the UE. A callback from an emergency device, in examples, is a call originating from an emergency device and ending on the UE. The emergency device places or otherwise originates a callback to the UE. The mobile originating device may be associated with a PSAP (i.e., be a device at the PSAP) or may be associated with a particular emergency service (e.g., be a device such as a wireless device carried by an emergency medical service provider).

These calls may be made from an emergency device using a long-form telephone number associated with the emergency service. As a result, the network may be unaware of the emergency status of the emergency device and not prioritize the follow-up call. By not prioritizing the follow-up call, the UE and the emergency device are connected using a default IP multimedia subsystem access point name (IMS APN).

However, when using a default IMS APN, the connection between the UE and the emergency device associated with the emergency callback may be subject to limits on connectivity including prioritization of the call and ability to obtain location information. As a result, the emergency callback may be missed due to a lack of connectivity or dropped in the middle of the call. This may result in communication delays between the UE and the emergency device associated with an emergency service, PSAP, and/or first responder, leading to delays in the user receiving the appropriate assistance.

Exemplary embodiments described herein include methods and systems for establishing emergency APN connections for callbacks from emergency services. For example, upon receiving a call invite from an emergency device, a UE may determine that the emergency device corresponds to an emergency callback number or is otherwise associated with an emergency service. This determination may be made based on a previously received list of emergency callback numbers received by the UE, which may have been transmitted by the public safety access point (PSAP) during the original emergency call. Once the UE determines that the emergency device is associated with an emergency callback number, the UE may request an emergency APN for the callback from the emergency device. Upon request, the UE may receive an emergency APN, allowing the UE to connect to the emergency device via the emergency APN. By connecting via an emergency APN, instead of a default IMS APN, the mobile network can prioritize connectivity between the UE and the emergency device. This allows for reliable communication between the user of the UE and the emergency service provider associated with the emergency device, resulting in the emergency service provider being able to gather additional information and provide services in a more efficient manner on a prioritized call.

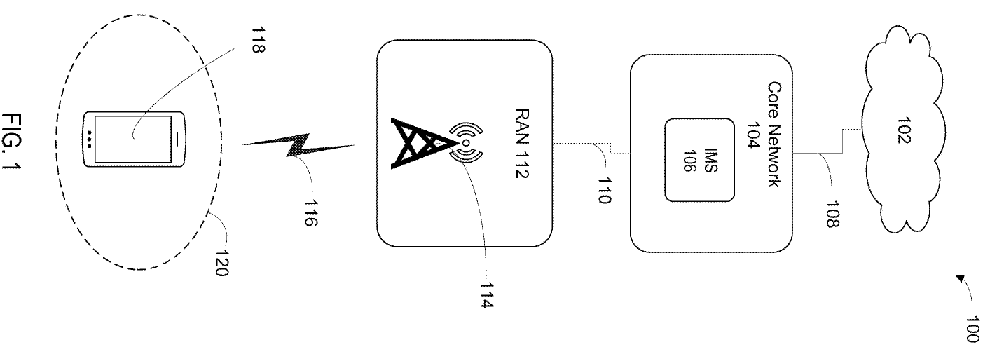

These and other examples will be described in greater detail below in relation to FIGS. 1-5.

FIG. 1 depicts an exemplary system 100 for wireless communication. System 100 includes a communication network 102, a core network 104 and a radio access network (RAN) 112, including at least one access node 114. The RAN 112 may include other devices and additional access nodes. Although one access node is shown, any number of access nodes may be included.

System 100 also includes UE 118, which may be an end-user device and may operate within a coverage area 120. The UE 118 may communicate with an access node 114 within the RAN 112 over a communication link 116.

Communication network 102 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 102 can be capable of carrying data, for example, to support voice, push-to-talk, broadcast video, and data communications by UE 118. Wireless network protocols can comprise Fifth Generation mobile networks or wireless systems (4G or 4G LTE) or 5G. Wired network protocols that may be utilized by communication network 102 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 102 can also comprise additional base stations, controller nodes, telephony switches, internet routers, network gateways, computer systems, communication links, or some other type of communication equipment, and combinations thereof.

The core network 104 includes the IP Multimedia Subsystem (IMS) 106. The core network 104 may be separated into user plane functions and control plane functions. The user plane accesses a data network, such as network 102, and performs operations such as packet routing and forwarding, packet inspection, policy enforcement for the user plane, quality of service (QoS) handling, etc. The control plane handles radio-specific functionality that depends on the idle or connected states of the UE 118.

Core network 104 may include an IP multimedia subsystem (IMS) 106. IMS 106 as used herein is a framework used for delivering IP multimedia services, such as voice over internet protocol (VoIP) and/or other similar services, across a network. IMS 106 may include a call session control function (CSCF). The CSCF as used herein is a component of IMS 106 used for session control, signaling and routing in multimedia communication. In embodiments, the CSCF may be used for handling session initiation protocol (SIP) communication. In embodiments, IMS 106 may be used for communication between entities or components of network 102 and UE 118. For example, the CSCF of the IMS 106 may be used for communication between UE 118. Communication links 108 and 110 can use various communication media, such as air, space, metal, optical fiber, or some other signal propagation path - including combinations thereof. Communication links 108 and 110 can be wired or wireless and use various communication protocols such as Internet, Internet protocol (IP), local-area network (LAN), S1, optical networking, hybrid fiber coax (HFC), telephony, T1, or some other communication format - including combinations, improvements, or variations thereof. Wireless communication links may use electromagnetic waves in the radio frequency (RF), microwave, infrared (IR), or other wavelength ranges, and may use a suitable communication protocol, including 4G including 4G NR or 4G Advanced, 6G, NTN, or combinations thereof.

Communication links 108 and 110 can be direct links or might include various equipment, intermediate components, systems, and networks, such as a cell site router, etc. Communication links 108 and 110 may comprise many different signals sharing the same link.

The RAN 112 may include an access network system and device such as access node 114. The RAN 112 is disposed between the core network 104 and the UE 118. Components of the RAN 112 may communicate directly with the core network 104 and others may communicate directly with the UE 118. The RAN 112 may provide services from the core network 104 to the UE 118.

The RAN 112 includes an access node (or base station) 114, which may include one or more access nodes communicating with the UE 118. It should be understood that the disclosed technology may also be applied to communication between a UE and other network resources, such as relay nodes, controller nodes, antennas, etc. The RAN 112 may further comprise a non-terrestrial network (NTN) serving the multiple UEs by a radio frequency transmission provided by utilizing orbiting satellites that may be in communication with access nodes of a terrestrial network (TN). The satellites may include geosynchronous equatorial orbit (GEO) satellites, Medium Earth Orbit (MEO) satellites, and low Earth orbit (LEO) satellites. The NTN may include NTN nodes that are not stationed on the ground.

Access node 114 can be, for example, standard access nodes such as a macro-cell access node, a base transceiver station, a radio base station, an evolved NodeB (or eNodeB) in 4G or 4G LTE, a next generation NodeB (or gNodeB) in 5G New Radio (“5G NR”), or other generations of radio base station nodes. In some embodiments, access node 114 may include at least one antenna which transmits cellular signals. In additional embodiments, access nodes may comprise two co-located cells, or antenna/transceiver combinations that are mounted on the same structure. Alternatively, access node 114 may comprise a short range, low power, small-cell access node such as a microcell access node, a picocell access node, or a femtocell access node. Access node 114 can be configured to deploy one or more different carriers, utilizing one or more RATs. Any other combination of access nodes and carriers deployed therefrom may be evident to those having ordinary skill in the art in light of this disclosure.

The access node 114 and servers in the IMS 106 may comprise a processor and associated circuitry to execute or direct the execution of computer-readable instructions. They may retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The UE 118 may include any UE included in a wireless network. UE 118 may include any device configured to send and receive messages over session initiated protocol (SIP). For example, the term “UE” may include a relay node, which may communicate with an access node. The term “UE” may also include an end-user UE, which may communicate with the access node through a relay node. The term “UE” may further include an end-user UE that communicates with the access node directly without being relayed by a relay node. UE 118 may be any device, system, combination of devices, or other such communication platform capable of communicating wirelessly with access node 114 using one or more frequency bands and wireless carriers deployed therefrom. UE 118 may be, for example, a mobile phone, a wireless phone, a wireless modem, a personal digital assistant (PDA), a voice over internet protocol (VoIP) phone, a voice over packet (VOP) phone, or a soft phone, a wearable device, an internet of things (IoT) device, as well as other types of devices or systems that can send and receive audio or data. UE 118 may be or include high power UEs or standard power UEs.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). Communication system 100 may be capable of communicating signals and carrying data, for example, to support voice, push-to-talk, broadcast video, and data communications by UE 118.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g., between the RAN 112 and the core network 104.

Although one core network 104 is shown, multiple core networks 104 may be utilized. Alternatively, the single core network 104 may include a distributed, cloud-native, converged core gateway. Thus, the converged core gateway could connect a 4G LTE evolved packet core (EPC) to a 5G core network.

Communication links 108 and 110 can use various communication media, such as air, space, metal, optical fiber, or some other signal propagation path, including combinations thereof. Communication links 108 and 110 can be wired or wireless and use various communication protocols such as Internet, Internet protocol (IP), local-area network (LAN), S1, optical networking, hybrid fiber coax (HFC), telephony, T1, or some other communication format - including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 108 and 110 can be direct links or might include various equipment, intermediate components, systems, and networks, such as a cell site router, etc. Communication links 108 and 110 may comprise many different signals sharing the same link.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for emergency access point name (APN) connection may be implemented as computer-readable instructions or methods, and processing nodes on the network and/or computing device, such as end user UE, for executing the instructions or methods. An access point name, or APN, defines a particular gateway between a mobile network and another computer network, such as the internet. More particularly, an APN defines a packet data network (PDN) that a user of a UE wants to communicate with. An IMS APN is a type of APN that specifically defines the type of service, in this case, an IP multimedia substation, being used. An IMS APN allows delivery of multimedia services, including voice calls and messaging, over an IP network. The processing node may include a processor included in the access node or a processor included in any controller node in the wireless network that is coupled to the access node. The computing device may include at least a processor and a memory with instructions configuring the processor to execute instructions.

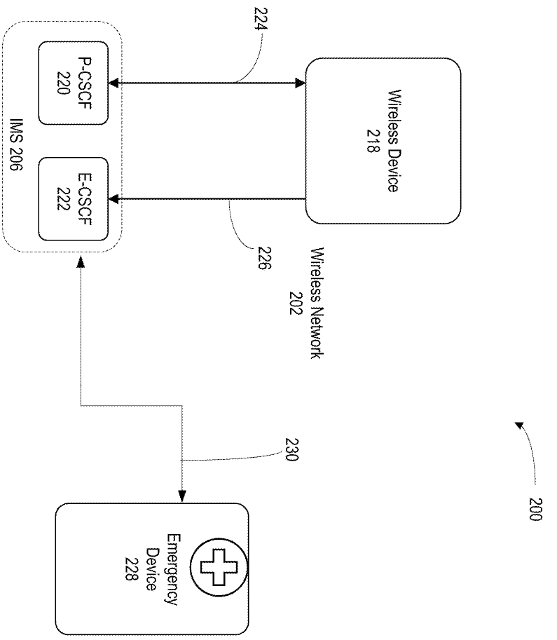

Now referring to FIG. 2, an example exemplary system 200 for emergency APN connection is presented. System 200 includes a UE 218 and an emergency device 228. UE 218 may be the same as UE 118. System 200 also includes wireless network 202. Wireless network 202 may include a RAN, core network and/or a communication network, which may be the same as, respectively, RAN 112, core network 104 and communication network 102. In some examples, wireless network 202 may be hosted by a mobile network operator (MNO).

The IMS 206 includes may include servers, including a proxy call session control function (P-CSCF) 220 and an emergency call session control function (E-CSCF) 222, shown, but it should be understood that there are many other types of IMS and core servers that are omitted for clarity. A proxy server, such as P-CSCF 220 receives a call request from a UE, as shown by arrow 224. Headers may be added to the call request in the form of SIP headers such as Resource Priority Header (RPH), X-MAV-RPH:911, Orig. ID, and Attestation-Info. The call request may then be forwarded to an emergency call management server such as E-CSCF 222 for further processing, as shown by arrow 226. E-CSCF 222 may query a gateway mobile location center (GMLC) for information about the destination network of the call. The GMLC returns information on a public safety access point (PSAP) that services the location of the UE that originated the call request. This information includes how to contact the PSAP. The UE 218 is then connected to the PSAP. The PSAP may use SIP trunking to connect to IMS 206, which allows the PSAP to send and receive voice and multimedia data over an IP network. The PSAP may use SIP and session description protocol (SDP) for managing session and session parameters.

In addition, system 200 may include an emergency device 228. Emergency device 228 may be a UE similar to UE 218 or may be another type of device able to make calls and connect to UE 218 via a request at the IMS 206, as shown by arrow 230. Emergency device 228 may be external to wireless network 202, i.e., may be part of a different wireless network. In examples, the emergency status of the emergency device 228 is unknown to the IMS 206 at the time the emergency device 228 places the call to the UE 218. In some examples, emergency device 228 is associated with a PSAP, while in other examples, emergency device 228 is associated with other emergency services. The callback number of emergency device 228 has been previously communicated to UE 218 in case of the original emergency call ends prematurely. UE 218 stores the callback number of emergency device 228 identifying it as an emergency callback number.

For example, during an emergency call between the UE 218 and a PSAP, the PSAP operator may determine which emergency service or services are most likely to be appropriate for response to the caller. The PSAP operator has access to a system that includes telephone numbers for various emergency responders and emergency services. Once the PSAP operator determines which emergency service(s) are appropriate, the PSAP operator may transmit a message to the UE 218 that includes numbers of the PSAP, emergency services, and/or first responders. The message may indicate that the transmitted number(s) are for emergency services. Once the UE 218 receives the message, the UE 218 updates its recognized call number list to tag the telephone number(s) received in the message as belonging to an emergency service. Thus, when the UE 218 receives a callback from an emergency device 228, the UE 218 will recognize that the telephone number is associated with an emergency service and should be prioritized. In addition, update messages may be transmitted if, for example, changes in emergency responder occur. Receiving such update messages allows the UE 218 to re-update its recognized call number list.

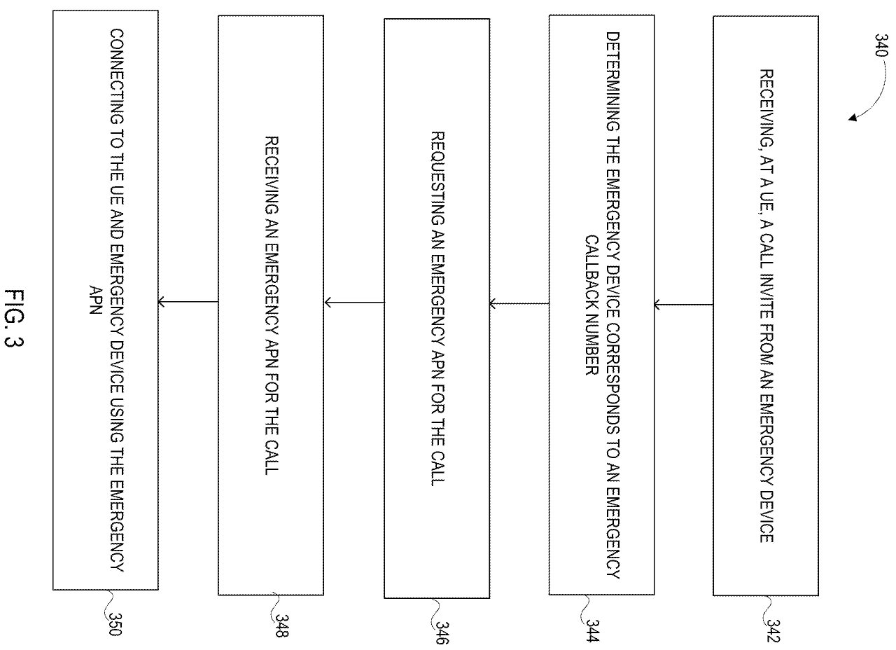

FIG. 3 illustrates an example method 340 for emergency APN connection. Method 340 may be performed by any suitable combination of processors discussed herein, for example a processor contained in an IMS, such as an E-CSCF server.

Method 340 begins at step 342 with receiving, at a UE, a call invite from an emergency device. The call invite may be a session initiation protocol (SIP) invite received by the UE. In some examples, the SIP invite is received via an IP multimedia subsystem data channel (IMS DC). The emergency device may be associated with a PSAP, emergency service and/or first responder. In some examples, the emergency device may be directly associated with a PSAP, i.e., may transmit a call from a PSAP operator to the UE. In other examples, the emergency device is associated with an emergency service provider that is connected to the PSAP, such as police, fire, EMS, or first responder.

Method 340 continues at step 344 with determining that the emergency device corresponds to an emergency callback number. Determining that emergency device corresponds to an emergency callback number includes retrieving, from the SIP invite received at step 342, the callback number associated with the emergency device, which is included within a header of the SIP invite. More particularly, the UE retrieves the Mobile Station International Subscriber Directory Number (MSISDN) of the emergency device. The MSISDN may identify the number is an emergency callback number. In some examples, the MSISDN is retrieved by retrieving the callback number associated with the emergency device.

Upon retrieving the callback number, the UE determines that the emergency callback number corresponds to a recognized emergency callback number. To determine that the emergency callback number corresponds to a recognized emergency callback number, the UE compares the retrieved callback number with stored emergency callback numbers. These stored emergency callback numbers may have been previously received via a SIP communication to the UE. More particularly, a SIP communication including a set of known emergency callback numbers may have been transmitted to the UE by a PSAP using a SIP communication. Upon receiving this SIP communication, the UE is able to store the set of known emergency callback numbers. This may allow the UE device to determine, as in step 344, that a subsequent SIP invite is from one of the known emergency callback numbers.

At step 346, method 340 includes requesting an emergency APN for the call from the emergency device. The request may occur responsive to a determination that the emergency device corresponds to an emergency callback number made in step 344. The emergency APN may be requested from an access and mobility management function (AMF) module, although examples are not so limited. An AMF module refers to the control plane function which handles requests from a UE, particularly with respect to a 5G network. More particularly, requesting an emergency APN may include a transmitting a service request via a packet data network (PDN).

Method 340 continues at step 348 with receiving an emergency APN for the call. The emergency APN may be assigned and transmitted to the UE in response to the request made by the UE at step 346. More particularly, the UE may receive the emergency APN from the AMF. The UE may receive the parameters associated with the emergency APN, including the PDN which will be used for the duration of the call.

At step 350, method 340 includes connecting to the emergency device. More particularly, the UE may connect to the emergency device using the emergency APN. Connecting to the UE using the emergency APN may include moving from an initial IMS APN, established when the initial call request is received at step 342, to the emergency APN. Once connected via the emergency APN, the UE and the emergency device are able to communicate with one another using the emergency APN, allowing the user and the emergency service provider to exchange information and for prioritization of the call.

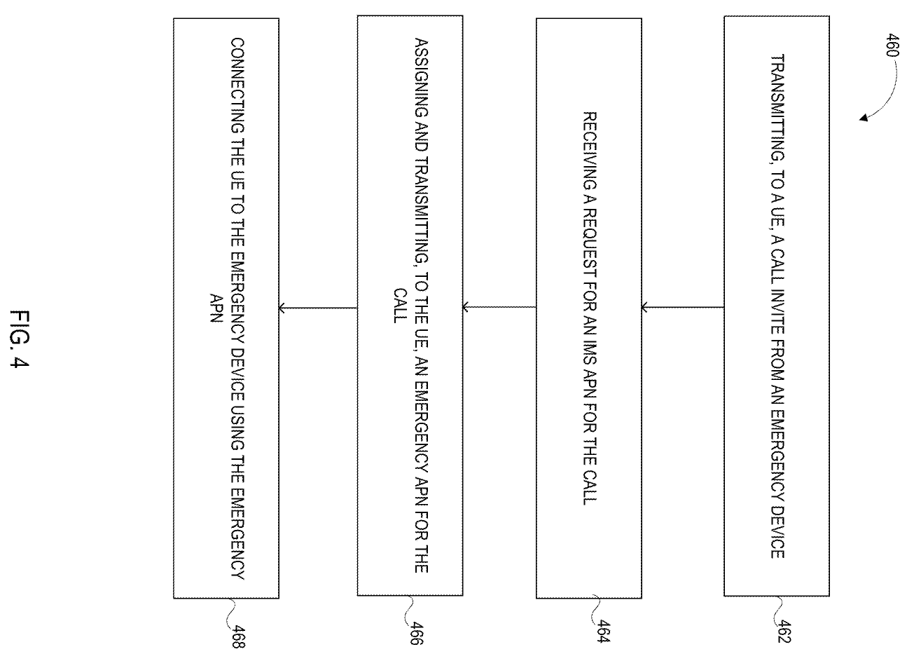

Turning now to FIG. 4, another example method 460 for emergency APN connection. Method 460 may be performed by any suitable combination of processors discussed herein, for example a processor contained in an IMS, such as an E-CSCF server.

Method 460 begins in step 462 with transmitting, to UE, a call invite from an emergency device. The emergency device may be associated with a PSAP, emergency service and/or first responder. In some examples, the emergency device is directly associated with the PSAP, such that a PSAP operator is able to make a call using the emergency device. In other examples, the emergency device corresponds to an emergency service provider, such that the emergency device is indirectly associated with the PSAP. The call invite may be transmitted from an access and mobility management function (AMF) module, although examples are not so limited.

In some examples, the UE is in an active mode when the call invite is transmitted at step 462, meaning that the UE is on an active session and connected to a particular packet data network (PDN) via an IMS APN. In such examples, the call invite from the emergency device is transmitted using a session initiated protocol (SIP) invite, or another form of SIP communication. In such examples, the SIP invite may be transmitted using an IP multimedia system data channel (IMS DC).

In some examples, the UE may be in an idle mode, i.e., may not be on an active session. In such examples, transmitting a call invite to a UE from an emergency device may include paging the UE from an access node. By paging the UE, the UE is alerted that a communication attempt is occurring. Once the UE has been paged, the access node may receive a radio resource control (RRC) connection request from the UE. RRC refers to the protocol that manages the establishment of a connection, as well as its release, as well as configuration of the connection via configuration of control planes. Thus, the RRC connection request from the UE corresponds to a request from the UE to the access node to establish and configure a connection. Upon receiving the RRC connection request from the UE, the access node may accept the RRC connection request and establish the connection. The UE is then connected to the emergency device via a default IP AMS.

At 464, method 460 includes receiving a request for an emergency access point name (APN) for the call from the UE. The request may come from the UE and may be received in receiving the call invite from an emergency device at step 462. In some examples, the request is a service request received via a packet data network (PDN).

Method 460 continues in step 466 with assigning and transmitting the emergency APN for the call. The emergency APN may be assigned to the call and may be assigned and transmitted from the AMF. Assigning the emergency APN at step 466 may include transmitting the parameters associated with the emergency APN, including the PDN which will be used for the duration of the call.

At step 468, method 460 includes connecting the UE to the emergency device. The connection between the UE and the emergency device may occur using the emergency APN. More particularly, the initial IMS APN connection between the mobile terminating device and the mobile originating device may be transferred to the emergency APN. Once connected via the emergency APN, the UE and the emergency device are able to communicate with one another using a prioritized emergency APN.

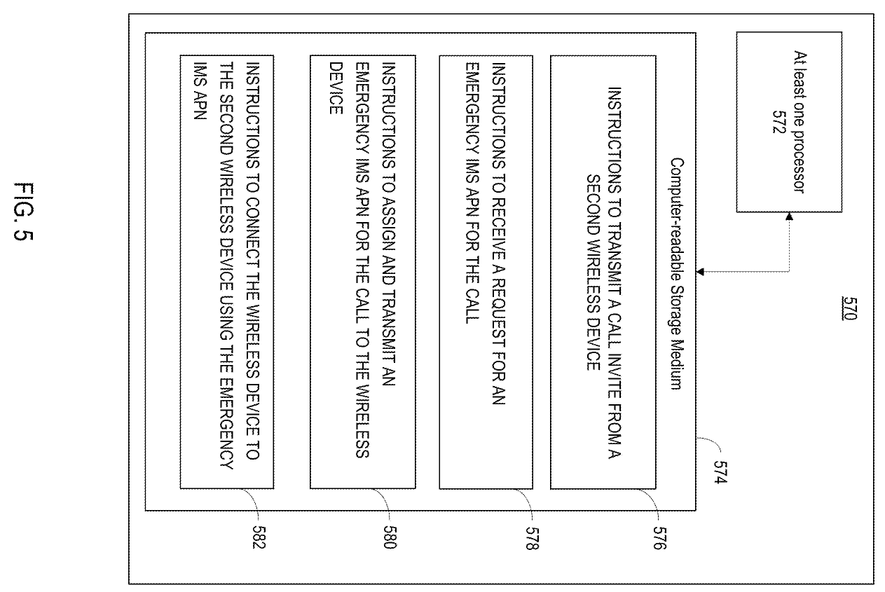

Now referring to FIG. 5, an example computing device 570 is presented. In embodiments, computing device 570 may include a node device, such as devices operating within communication network described in reference to FIG. 1. In this example, computing device 570 includes at least one processor 572 communicably coupled to a computer-readable storage medium 574. The at least one processor 572 may include a microprocessor, a microcontroller, one or more central processing unit (CPU) cores, an application-specific integrated circuit (ASIC), one or more graphical processing unit (GPU) cores, a field programmable gate array (FPGA), and/or any other hardware device suitable for retrieval and execution of instructions from computer-readable storage medium 574. In instances, at least one processor 572 may include electronic circuitry for performing instructions described in this disclosure.

In instances, computer-readable storage medium 574 may be any medium suitable for storing executable instructions. In examples, without limitation, computer-readable storage medium 574 may include read-only memory (ROM), random-access memory (RAM), erasable electrically programmable ROM (EEPROM), Solid State Drive (SSD), optical disc, and the like. Computer-readable medium storage 574 may be disposed within computing device 570. In embodiments, computer-readable storage medium 574 may be external, and communicably connected, to computing device 570. The instruction stored on computer-readable storage medium may be used to implement method steps described in reference to FIGS. 3 and 4.

In this example, computer-readable storage medium 574 is encoded with a set of instructions 576, 578, 580, and 582. In embodiments, executable instructions included in each block may be included in different blocks shown and blocks not shown.

Instructions 576, when executed by at least one processor 572, configures the at least one processor 572 to transmit a call invite from an emergency device to a UE. The call invite may be transmitted using a session initiated protocol (SIP) invite and may be transmitted via an IP multimedia subsystem data channel (IMS DC). The emergency device may be associated with a public safety access point (PSAP), emergency service and/or first responder. Upon receiving the call invite, the UE device and the emergency device may be connected using an IMS APN.

Instructions 578, when executed by at least one processor 572, configures the at least one processor 572 to receive a request for an emergency. The request may be received from the UE and may be a request for an emergency APN for the call from the emergency device. In some examples, the request for an emergency APN may be a service request received via a packet data network (PDN). In some examples, the request for an emergency APN received at instructions 578 may occur in response to the transmission of a call invite from an emergency device at instructions 576. In such examples, the emergency APN may be received at instructions 578 upon a determination at the UE that the emergency device corresponds to an emergency callback number.

Instructions 580, when executed by at least one processor 572, configures the at least one processor 572 to assign an emergency APN for the call to the UE. The instructions to assign an emergency APN may include instructions to transmit the parameters associated with the emergency APN, including the PDN which will be used for the duration of the call.

Instructions 582, when executed by at least one processor 572, configures the at least one processor 572 to connect the UE to the emergency device using the emergency APN. . More particularly, an initial IMS APN between the UE and the emergency device may be terminated to allow the connection to be moved to the emergency APN. Upon connection of the UE to the emergency device via the emergency APN, the UE and the emergency device are able to communicate with one another.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, comprising:
receiving, at a user equipment (UE), a call invite from an emergency device;
determining the emergency device corresponds to an emergency callback number;
requesting, at the UE, from a wireless network, an emergency access point name (APN) for the call from the emergency device;
receiving, at the UE, an emergency APN for the call; and
connecting to the emergency device using the emergency APN.

2. The method of claim 1, wherein the call invite from an emergency device is a session initiation protocol (SIP) invite.

3. The method of claim 1, wherein the emergency device is an emergency service provider.

4. The method of claim 1, wherein the UE has stored emergency callback numbers from previously received SIP communications.

5. The method of claim 4, wherein the emergency callback number is included in a set of known emergency callback numbers previously transmitted to the UE by a public safety access point (PSAP).

6. The method of claim 1, further comprising:
retrieving, from a received SIP INVITE, the emergency callback number; and
determining that the emergency callback number corresponds to a recognized emergency callback number.

7. The method of claim 6, wherein the received SIP invite is received via an IP multimedia subsystem data channel (IMS DC).

8. The method of claim 1, wherein transmitting a service request for an emergency APN comprises transmitting a service request via a packet data network (PDN).

9. A method, comprising:
transmitting, to a UE, a call invite from an emergency device;
receiving, from the UE, a request for an emergency IP multimedia subsystem access point name (IMS APN) for the call from the emergency device;
assigning, to the UE, an emergency APN for the call; and
connecting the UE to the emergency device using the emergency APN.

10. The method of claim 9, wherein the call invite from the emergency device is a session initiated protocol (SIP) invite transmitted via an IP multimedia subsystem data channel (IMS DC).

11. The method of claim 9, wherein the emergency device is associated with a public safety access point (PSAP).

12. The method of claim 9, wherein the emergency device is associated with an emergency service provider.

13. The method of claim 9, wherein receiving a service request for an emergency APN comprises receiving a service request via a packet data network (PDN).

14. The method of claim 9, wherein assigning, to a UE, a call invite from an emergency device comprises:
paging, from an access node, the UE;
receiving, at the access node, a radio resource control (RRC) connection request from the UE; and
accepting the RRC connection request.

15. A system, comprising:
a memory storing data and instructions; and
a processor executing the stored instructions to perform operations including:
transmitting, to a UE, a call invite from an emergency device;
receiving, from the UE, a request for an emergency access point name (APN) for the call from the emergency device;
assigning, to the UE, an emergency APN for the call; and
connecting the UE to the emergency device using the emergency APN.

16. The system of claim 15, wherein the call invite from the emergency device is a session initiated protocol (SIP) invite transmitted via an IP multimedia subsystem data channel (IMS DC).

17. The system of claim 15, wherein the emergency device is associated with a public safety access point (PSAP).

18. The system of claim 15, wherein the emergency device is associated with an emergency service provider.

19. The system of claim 15, wherein receiving a service request for an emergency APN comprises receiving a service request via a packet data network (PDN).

20. The system of claim 15, wherein it has been determined by the UE that the emergency device corresponds to an emergency callback number.
